(19) United States
(12) Patent Application Publication
(10) Pub. No.: US 2013/0191829 A1
(43) Pub. Date: Jul. 25, 2013

(54) COMPUTER SYSTEM, VIRTUAL SERVER ALIGNMENT METHOD, AND ALIGNMENT CONTROL APPARATUS

(71) Applicant: Hitachi, Ltd., Tokyo (JP)

(72) Inventors: Isao Shimokawa, Mitaka (JP); Toshiaki Tarui, Sagamihara (JP); Toshiaki Suzuki, Hachioji (JP)

(73) Assignee: Hitachi, Ltd., Tokyo (JP)

(21) Appl. No.: 13/742,874

(22) Filed: Jan. 16, 2013

(30) Foreign Application Priority Data
Jan. 19, 2012 (JP) 2012-008645

(51) Int. Cl. G06F 9/455

(52) U.S. Cl. CPC G06F 9/455
USPC 718/1

(57) ABSTRACT

A computer system comprising a plurality of clients, a plurality of servers, a plurality of routers, an analysis device for monitoring communication statuses of the plurality of routers, and a management computer for controlling alignment of a virtual machine operating on each of the plurality of servers, the each of the plurality of routers including an information obtaining module for obtaining communication information for each flow, the analysis device including: an analysis module for analyzing the communication information; and a probability calculation module for calculating a occurrence probability of packet drop, the management computer including: a load estimation module for estimating a load for each of communication routes for moving the virtual machine; and an alignment determination module for determining, based on the occurrence probability of packet drop, the communication route of the movement destination.

### CLAIM OF PRIORITY

The present application claims priority from Japanese patent application JP 2012-8645 filed on Jan. 19, 2012, the content of which is hereby incorporated by reference into this application.

### BACKGROUND OF THE INVENTION

This invention relates to control of virtual server alignment. In particular, this invention relates to a system, method, and apparatus for controlling virtual server alignment in consideration of a network load in virtual servers.

Cloud computing has recently been proposed as a service for providing all kinds of computer resources. Through use of the cloud computing, it is possible to provide computer resources, which are owned by companies that provide services to users, from different locations to the users. Through introduction of the cloud computing, it is possible to provide merits in terms of speed, price, and the like.

One problem in the cloud computing is how to lower power consumption. The services using the cloud computing are hereinafter referred to as cloud services.

In providing the cloud services to a large number of users, the companies that provide the cloud services need to continue building data centers for storing a large amount of data including personal information endlessly.

In order to improve reliability of communication, applications are processed dispersedly and most systems as network systems have a redundant configuration, and hence there is a concern that the power consumption increases exponentially along with the increase in number of data centers.

Further, along with the expansion of cloud services in the future, it is expected that the number of users who access the data centers also increases exponentially, with the result that the traffic and the power consumption increase exponentially.

In a large-scale cloud computing system, in order to realize a system having low power consumption while securing availability, it is necessary to efficiently scale down the enlarged cloud computing system and optimize the virtual server alignment. Specifically, it is necessary for a management server included in the system to determine a communication route for moving a virtual server to another data center.

In order to solve the above-mentioned problem, the management server for re-aligning the virtual servers needs to select a route for connecting to the most reliable server via the most reliable network. More specifically, when a virtual server is to be moved to another data center, the management server needs to estimate a probability of packet drop in a router included in a movement route considering an amount of communication bandwidth of a flow that has been connected to the virtual server.

It is because, if there is a router having a tight bandwidth due to the occurrence of congestion in the movement route, when the flow connected to the virtual server passes through the router, a large amount of packets are dropped.

Therefore, in order to avoid the dropping of the large amount of packets, it is necessary to monitor the traffic flowing through the router and identify the traffic status at present. Further, it is necessary to define a parameter for estimating the probability of packet drop in each router from the traffic status.

For example, Japanese Patent Application Laid-open No. 2011-82799 describes measuring a network status by using Open Flow and by controlling virtual server alignment based on the measurement result.

### SUMMARY OF THE INVENTION

However, while Japanese Patent Application Laid-open No. 2011-82799 describes controlling the virtual server alignment by allocating resources optimally, consideration is not given to the amount of communication bandwidth of a flow connected to the virtual server, that is, the probability of packet drop in the router included in the movement route.

With the method described in Japanese Patent Application Laid-open No. 2011-82799, the communication efficiency of the network after changing the virtual server alignment may be low. In this case, retransmission of data occurs, and hence power saving cannot be realized and the quality of service (QoS) required by the users cannot be satisfied.

This invention has been made to solve the above-mentioned problems. Specifically, exemplary embodiments of this invention provide a system, method, and apparatus for selecting a route that can avoid dropping of a large amount of packets considering a communication status of a router included in a movement route.

The present invention can be appreciated by the description which follows in conjunction with the following figures, wherein: a computer system comprising a plurality of clients, a plurality of servers, a plurality of routers, an analysis device for monitoring communication statuses of the plurality of routers, and a management computer for controlling alignment of a virtual machine operating on each of the plurality of servers. The virtual machine provides a predetermined service to the plurality of clients. Each of the plurality of clients including a first processor, a first memory connected to the first processor, and a first network interface for coupling to another device, the each of the plurality of servers including a second processor, a second memory connected to the second processor, and a second network interface for coupling to another device, each of the plurality of routers including a controller, and a third network interface for coupling to another device, the analysis device including a fourth processor, a fourth memory connected to the fourth processor, and a fourth network interface for coupling to another device, the management computer including a fifth processor, a fifth memory connected to the fifth processor, and a fifth network interface for coupling to another device. The each of the plurality of servers including a virtualization control module for controlling the virtual machine. The each of the plurality of routers including an information obtaining module for obtaining communication information for each flow, which is a set of a plurality of packets and is defined based on header information of packets that pass through the router, and for transmitting the obtained communication information to the analysis device. The analysis device including: an analysis module for analyzing the communication information received from the each of the plurality of routers and for outputting an analysis result; and a probability calculation module for calculating, based on the analysis result, a first occurrence probability of packet drop representing a degree of risk that packet drop occurs in a router included in a communication route of a movement destination in a case where the virtual machine is moved. The management computer including: a load estimation module for estimating, based on the analysis result, a load for each of communication routes for moving the virtual machine as a movement target, and for identifying at least one candidate route, which is the communication route as a candidate of the movement destination; and an alignment determination module for determining, based on the first occurrence probability of packet drop, the communication route of the movement destination from among the at least one candidate route.

According to the exemplary embodiments of this invention, the communication route of the movement destination may be selected from among the candidate routes based on the occurrence probability of packet drop, which is the degree of risk that packet drop occurs, and hence a safer and more appropriate alignment of the virtual machines may be realized.

### BRIEF DESCRIPTION OF THE DRAWINGS

The present invention can be appreciated by the description which follows in conjunction with the following figures, wherein:

FIG. 1 is an explanatory diagram illustrating a configuration example of a computer system according to a first embodiment of this invention;

FIG. 2 is an explanatory diagram illustrating a format of an AFM packet according to the first embodiment of this invention;

FIG. 3 is an explanatory diagram illustrating an example of the computer system after a migration according to the first embodiment of this invention;

FIG. 4 is a block diagram illustrating an example of the configuration of an IMF according to the first embodiment of this invention;

FIG. 5 is a block diagram illustrating an example of the configuration of an integrated management server according to the first embodiment of this invention;

FIGS. 6A and 6B are explanatory diagrams illustrating examples of traffic statuses of routers, respectively, according to the embodiment of this invention;

FIGS. 7A and 7B are explanatory graphs showing examples of distributions of traffic flowing through the routers according to this embodiment;

FIG. 8 is a sequence chart illustrating a flow of processing according to the first embodiment of this invention;

FIG. 9 is a flowchart illustrating the details of the processing executed by the IMF according to the first embodiment of this invention;

FIG. 10 is a flowchart illustrating the details of the processing executed by the integrated management server according to the first embodiment of this invention;

FIG. 11 is a flowchart illustrating a processing of estimating the load according to the first embodiment of this invention; and

FIG. 12 is a standard deviation of a traffic distribution of an insertion bandwidth according to the second embodiment of this invention.

### DETAILED DESCRIPTION OF THE PREFERRED EMBODIMENTS

### First Embodiment

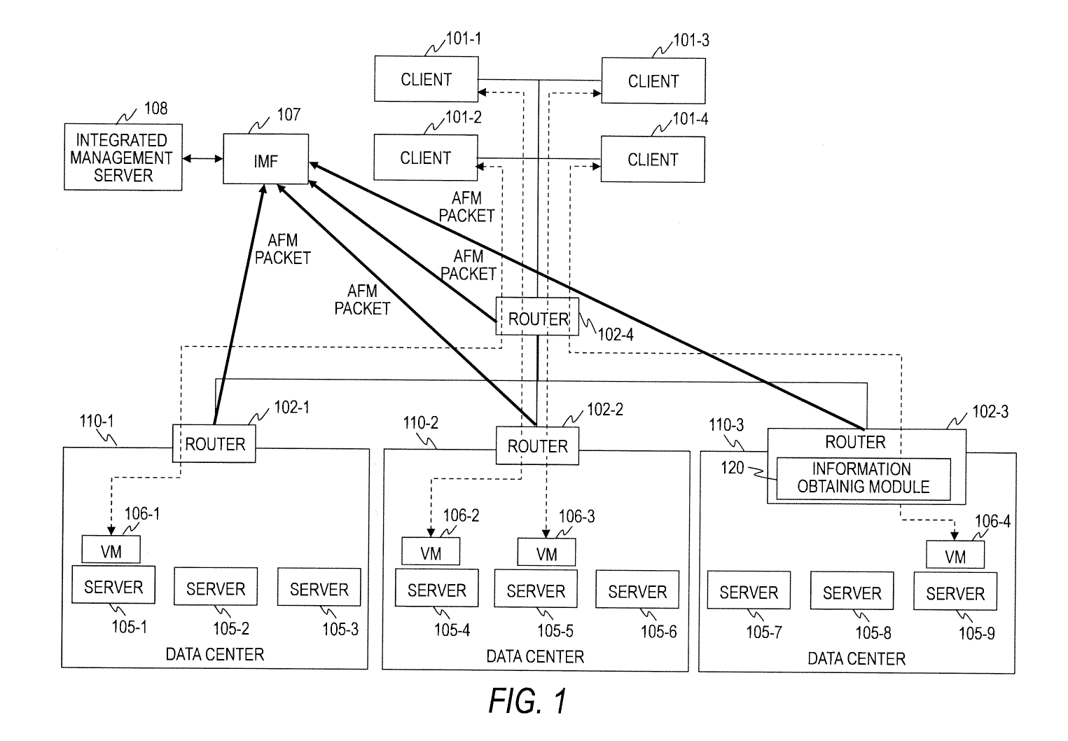

FIG. 1 is an explanatory diagram illustrating a configuration example of a computer system according to a first embodiment of this invention.

The computer system according to the first embodiment includes clients 101, routers 102, integrated mining of flow (IMF) 107, an integrated management server 108, and data centers 110. It should be noted that each of the data centers 110 includes a plurality of servers 105.

It should be noted that the clients 101, the routers 102, the integrated mining of flow (IMF) 107, the integrated management server 108, and the data centers 110 are communicably connected to one another.

In this embodiment, the integrated management server 108 estimates the future traffic status based on the current status of the traffic (amount of communication) and controls alignment of virtual servers (VMs 106). Therefore, in order to identify the traffic statuses of the routers 102 included in the routes connecting the routers 102 and the VMs 106, it is required that the integrated management server 108 obtain statistical information such as amounts of packets that have passed through the routers 102 in a predetermined period of time.

Accordingly, in this embodiment, aggregated flow mining (AFM) is used as a technology of obtaining the above-mentioned statistical information. The AFM is a technology of providing the statistical information used by an operator to quickly find, from among a large amount of traffic, a characteristic flow or an abnormal flow that inhibits normal operation of the network.

As another technology of obtaining the statistical information, the simple network management protocol (SNMP) is known. However, in the SNMP, a management information base (MIB) is used. Therefore, in a case where the statistical information is transmitted to an administrator, information is exchanged between the SNMP and the MIB at low speed, and hence real-time statistical information cannot be transmitted. Further, the statistical information obtained through use of the SNMP is, for example, queue information of the routers 102, which is often rough information. In other words, information for identifying the traffic status is insufficient.

On the other hand, as opposed to the SNMP, the AFM is a protocol specialized in transmitting the statistical information on the abnormal flow or the characteristic flow to the administrator, and does not require a database such as the MIB in the SNMP. Further, an apparatus to which the AFM is applied stores a database on a random access memory (RAM) and searches the statistical information by using a hash function to exchange information at high speed. Therefore, the processing overhead is low, and large capacity traffic can be handled. Further, in the AFM, information is handled for each flow, and hence more detailed information can be obtained as compared to the SNMP.

Now, an AFM packet used in the AFM is described.

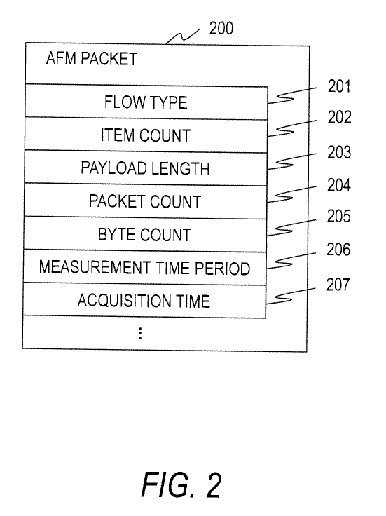

FIG. 2 is an explanatory diagram illustrating a format of the AFM packet according to the first embodiment of this invention.

In general, a set of packets having, of items included in an internet protocol (IP) header or a transmission control protocol/user datagram protocol (TCP/UDP) header, identical 5-tuple values (source IP address, destination IP address, protocol, source port number, destination port number) is defined as a flow.

In the AFM, the above-mentioned idea is expanded to define a set of packets having identical arbitrary n-tuple as an aggregated flow, and the statistical information such as a packet count and a byte count is collected in units of the aggregated flow.

Through introduction of the concept of the aggregated flow, it is possible to obtain the statistical information by regarding communications flowing between 1:n hosts as in, for example, a distributed denial of service (DDoS) attack or network scanning, as a single flow. Therefore, the behavior of traffic flowing on the network can be identified more easily. The aggregated flow is hereinafter simply referred to as flow.

As illustrated in FIG. 2, an AFM packet 200 includes a flow type 201, an item count 202, a payload length 203, a packet count 204, a byte count 205, a measurement time period 206, an acquisition time 207, and the like. It should be noted that the AFM packet 200 may also include other information. Further, the information items included in the AFM packet 200 are well known, and hence description thereof is omitted.

In this embodiment, each of the routers 102 to which the AFM technology is applied generates the AFM packet as illustrated in FIG. 2 and transmits the generated AFM packet to the IMF 107.

Next, the configuration of the computer system according to this embodiment is described.

The clients 101-1 to 101-4 are computers to be used by users. Each of the clients 101-1 to 101-4 has a processor (not shown), a memory (not shown), and a network interface (not shown). It should be noted that each of the clients 101-1 to 101-4 may also have other components such as a hard disk drive (HDD). When not distinguished, the clients 101-1 to 101-4 are hereinafter referred to as the clients 101.

Each of the data centers 110-1 to 110-3 includes a plurality of physical servers. Specifically, the data center 110-1 includes servers 105-1 to 105-3, the data center 110-2 includes servers 105-4 to 105-6, and the data center 110-3 includes servers 105-7 to 105-9. When not distinguished, the data centers 110-1 to 110-3 are hereinafter referred to as the data centers 110. Similarly, when not distinguished, the servers 105-1 to 105-9 are hereinafter referred to as the servers 105.

It should be noted that the data center 110 may also include other devices such as a network switch. Further, the data center 110 may also include a management server for managing the servers 105 in the data center 110.

The server 105 includes a processor (not shown), a memory (not shown), a storage medium (not shown), and a network interface (not shown). Examples of the storage medium (not shown) may include a hard disk drive (HDD) and a solid state drive (SSD). It should be noted that the server 105 may be configured to be connected to an external storage device.

The server 105 also includes a virtualization control module (not shown) for controlling the virtual machine (VM) 106. This enables at least one VM 106 to operate on the server 105. In this embodiment, a service is provided to a user by connecting a client 101 and a server 105 included in a predetermined data center 110 and causing a VM 106 to operate on the connected server 105.

In the example illustrated in FIG. 1, the clients 101 and the servers 105 have the following connecting relationship. The client 101-1 is connected to the server 105-4 of the data center 110-2, and a VM 106-2 operates on the server 105-4. The client 101-2 is connected to the server 105-1 of the data center 110-1, and a VM 106-1 operates on the server 105-1. The client 101-3 is connected to the server 105-5 of the data center 110-2, and a VM 106-3 operates on the server 105-5. Further, the client 101-4 is connected to the server 105-9 of the data center 110-3, and a VM 106-4 operates on the server 105-9.

The routers 102-1 to 102-4 relay data (packets) transmitted and received between devices. Each of the routers 102-1 to 102-4 has a controller (not shown) including a processor (not shown) and a memory (not shown), and a network interface (not shown). Further, the network interface (not shown) has a plurality of ports. When not distinguished, the routers 102-1 to 102-4 are hereinafter referred to as the routers 102.

The router 102 in this embodiment includes an information obtaining module 120 to which the AFM is applied. The information obtaining module 120 obtains communication information indicating a traffic status for each flow that passes through the router 102, and transmits the AFM packet including the obtained communication information to the IMF 107.

Specifically, the router 102 including the information obtaining module 120 mirrors the plurality of ports included in the router 102, and aggregates mirrored information to obtain the communication information for generating the AFM packet. Therefore, in a case where the communication information is obtained, communications that pass through the router 102 are not affected. The router 102 also generates the AFM packet based on the obtained communication information and transmits the AFM packet to the IMF 107.

In the example illustrated in FIG. 1, the router 102-4 connects the clients 101 and the routers 102-1 to 102-3 of the data centers 110. It should be noted that the router 102-4 and the clients 101, and the router 102-4 and the routers 102-1 to 102-3 are connected, for example, via a network such as a wide area network (WAN). Further, the routers 102-1 to 102-3 connect the router 102-4 and the servers 105 constituting the data centers 110-1 to 110-3, respectively. It should be noted that the routers 102 and the servers 105 are connected via, for example, a network such as a local area network (LAN).

It should be noted that this embodiment is not limited to the connecting form of the network.

The IMF 107 collects the AFM packets transmitted from the routers 102, and processes the collected AFM packets into a predetermined analyzable form to perform traffic analysis for each of the routers 102.

Specifically, the IMF 107 measures an amount of communication bandwidth for each flow that passes through each router, and measures traffic (amount of communication) of a flow corresponding to a VM 106 to be migrated. The IMF 107 estimates, based on the measured amount of communication bandwidth, a probability of exceeding a limit bandwidth of a router 102 included in a route connecting a client 101 and a server 105 of a migration destination, that is, a degree of risk (probability) that packet drop occurs. The IMF 107 further transmits the estimation result to the integrated management server 108. The probability that packet drop occurs is hereinafter also referred to as a occurrence probability of packet drop.

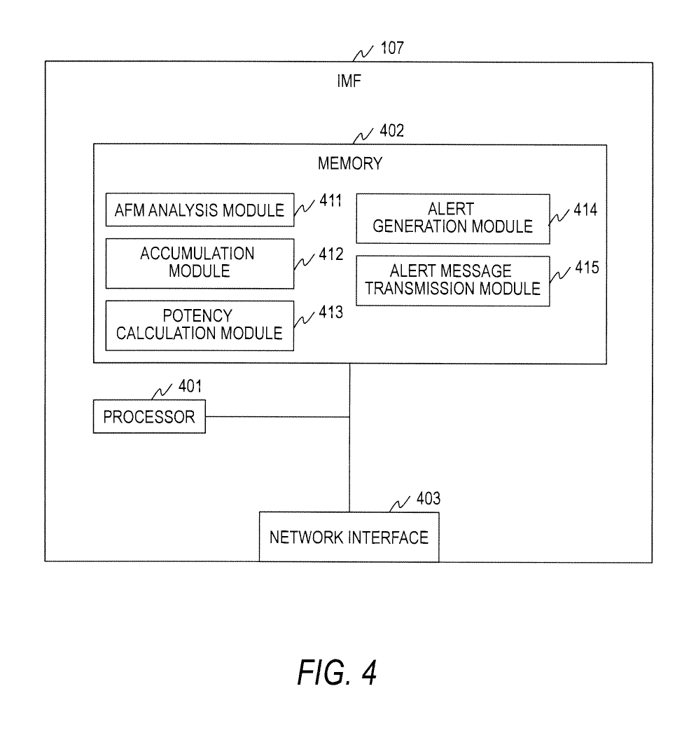

It should be noted that a detailed configuration of the IMF 107 is described below with reference to FIG. 4.

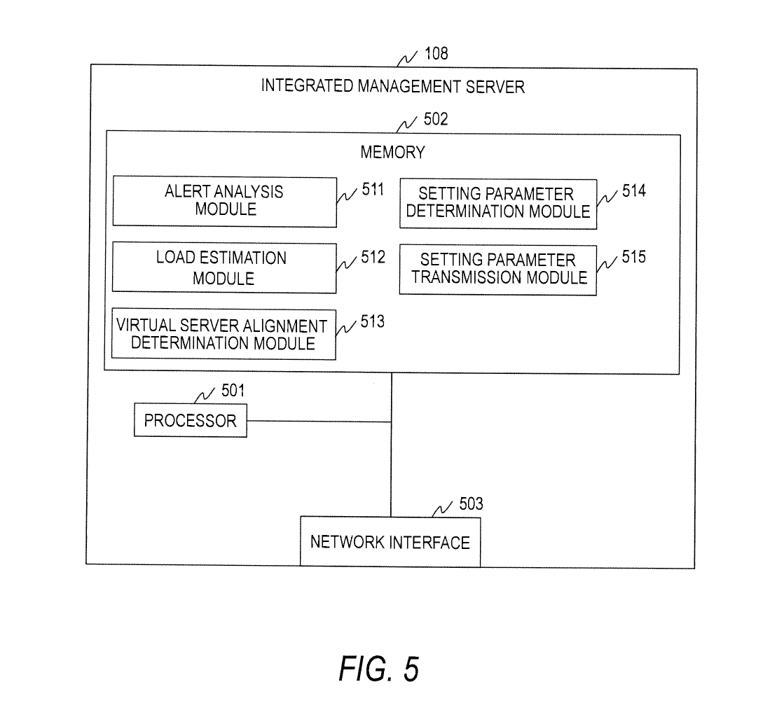

The integrated management server 108 manages the entire system. The integrated management server 108 also controls, based on the estimation result transmitted from the IMF 107, the alignment of the VMs 106. A detailed configuration of the integrated management server 108 is described below with reference to FIG. 5.

It should be noted that in the example illustrated in FIG. 1, only one IMF 107 and only one integrated management server 108 are provided, but a plurality of IMF 107 devices and a plurality of integrated management servers 108 may be provided.

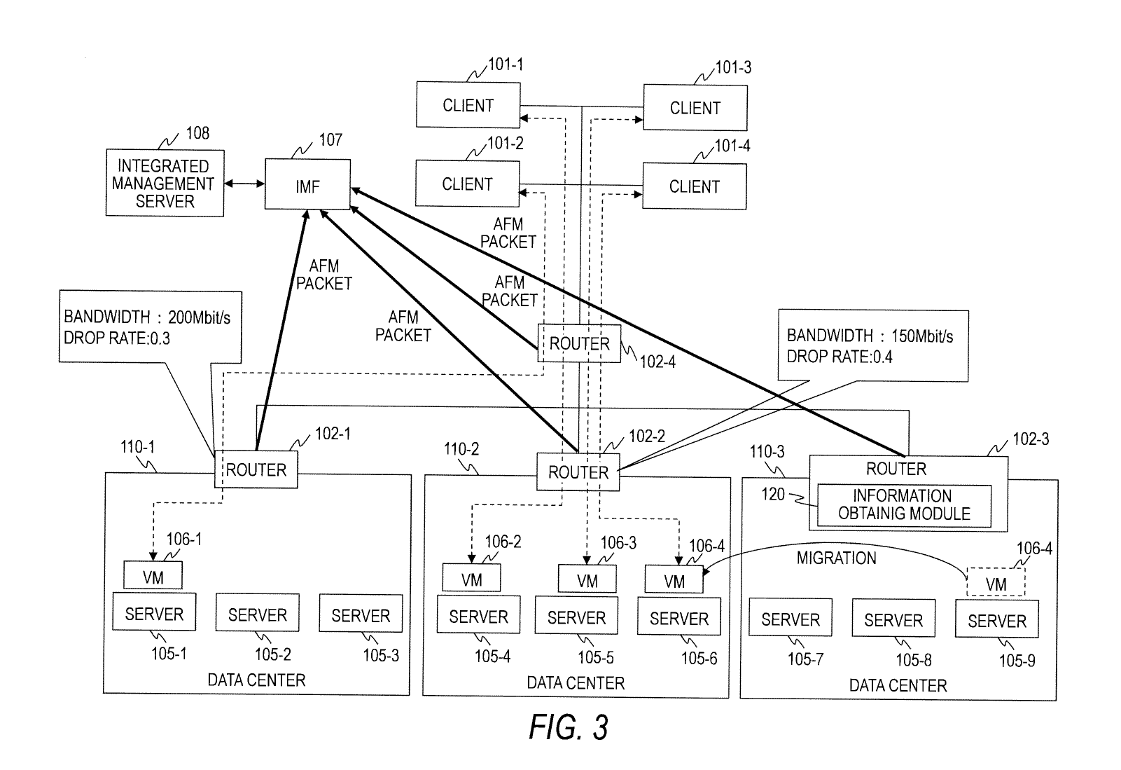

FIG. 3 is an explanatory diagram illustrating an example of the computer system after the migration according to the first embodiment of this invention.

In the example illustrated in FIG. 3, as a result of the migration, the VM 106-4, which has operated in the data center 110-3, is changed in alignment to the server 105-6 of the data center 110-2.

At this time, the traffic in a communication route connecting the client 101-4 and the VM 106-4 is changed from the route connecting the router 102-4 and the router 102-3 to the route connecting the router 102-4 and the router 102-2. It should be noted that the movement of the VM 106 by the migration is performed unnoticed by the user, and that the connecting between the client 101 and the VM 106 is maintained.

In the example illustrated in FIG. 3, the client 101-4 is connected to the data center 110-3 via the router 102-3. The integrated management server 108 obtains from the IMF 107 a result of monitoring the current traffic status, and selects the communication route of the movement destination based on estimation of the future traffic status.

However, in selecting the communication route of the movement destination, there may be a plurality of selectable communication routes. In the example illustrated in FIG. 3, there are a communication route connecting to the data center 110-1 via the router 102-1, and a communication route connecting to the data center 110-2 via the router 102-2.

It is assumed here that the router 102-1 has “200 Mbit/s” of the line bandwidth used and has a packet drop rate of “0.3”, and the router 102-2 has “150 Mbit/s” of the line bandwidth used and has a packet drop rate of “0.4”. It should be noted that the packet drop rate is a value representing a ratio of actually dropped packets to transmitted packets.

As a result of estimating the traffic by the integrated management server 108, it is assumed that an estimation result that none of the communication routes cause a problem in moving the VM 106 is obtained. In this case, if the integrated management server 108 easily selects the communication route via the router 102-1 or the communication route via the router 102-2 to move the flow, rapid packet drop may occur in the router 102 included in the communication route to which the flow is moved.

Therefore, there is a need to estimate in which of the routers 102, that is, the router 102-1 and the router 102-2, more packets are dropped, considering a communication bandwidth of the flow to be moved to the communication route via the router 102-1 and the communication route via the router 102-2.

Accordingly, the IMF 107 in this embodiment calculates the occurrence probability of packet drop in each of the routers 102 based on the analysis result of the AFM packets, and the integrated management server 108 selects a communication route based on the occurrence probability of packet drop. This enables re-alignment of the VMs 106 in consideration of not only the traffic status but also the amount of packet drop.

FIG. 4 is a block diagram illustrating an example of the configuration of the IMF 107 according to the first embodiment of this invention.

The IMF 107 has a processor 401, a memory 402, and a network interface 403.

The processor 401 executes programs stored in the memory 402. The processor 401 executes the programs, functions of the IMF 107 may be realized.

The network interface 403 is an interface for connecting to an external device via a network.

The memory 402 stores the programs to be executed by the processor 401 and information necessary for executing the programs. Specifically, the memory 402 stores an AFM analysis module 411, an accumulation module 412, a potency calculation module 413, an alert generation module 414, and an alert message transmission module 415.

The AFM analysis module 411 analyzes the AFM packets received by the network interface 403. The accumulation module 412 accumulates the AFM packets. It should be noted that the accumulation module 412 has a database for storing contents of the AFM packets, analysis results of the AFM packets, and the like. The potency calculation module 413 calculates, based on the accumulated AFM packets and analysis results, the probability of exceeding the limit bandwidth, that is, the occurrence probability of packet drop. It should be noted that the occurrence probability of packet drop is calculated by considering a communication bandwidth (insertion bandwidth) added by the movement of the flow corresponding to the VM 106 as a movement target. The flow corresponding to the VM 106 as the movement target is hereinafter also referred to as a target flow.

The alert generation module 414 generates a packet (alert message) including the analysis results of the AFM packets and the occurrence probability of packet drop. The alert message transmission module 415 transmits the alert message generated by the alert generation module 414 to the integrated management server 108.

It should be noted that in this embodiment, the AFM analysis module 411, the accumulation module 412, the potency calculation module 413, the alert generation module 414, and the alert message transmission module 415 are realized as programs, but this invention is not limited thereto. For example, special hardware may be used to realize the components.

Alternatively, a configuration may be employed in which at least two constituent modules from among the AFM analysis module 411, the accumulation module 412, the potency calculation module 413, the alert generation module 414, and the alert message transmission module 415 are implemented as one program.

FIG. 5 is a block diagram illustrating an example of the configuration of the integrated management server 108 according to the first embodiment of this invention.

The integrated management server 108 has a processor 501, a memory 502, and a network interface 503.

The processor 501 executes programs stored in the memory 502. The processor 501 executes the programs, functions of the integrated management server 108 may be realized.

The network interface 503 is an interface for connecting to an external device via a network.

The memory 502 stores the programs to be executed by the processor 501 and information necessary for executing the programs. Specifically, the memory 502 stores an alert analysis module 511, a load estimation module 512, a virtual server alignment determination module 513, a setting parameter determination module 514, and a setting parameter transmission module 515.

The alert analysis module 511 analyzes the alert message received by the IMF 107 and outputs the analysis result to the load estimation module 512. The load estimation module 512 estimates a load on a line based on the amount of communication bandwidth of each flow. The load estimation module 512 outputs the result of estimation of the load as load estimation information to the virtual server alignment determination module 513. The virtual server alignment determination module 513 determines the server 105 as a movement destination of the VM 106 based on the occurrence probability of packet drop and the load estimation information.

The setting parameter determination module 514 determines parameters necessary for moving the VM 106. The setting parameter transmission module 515 generates a packet including the determined parameters and transmits the packet to the server 105 as the movement destination.

It should be noted that in this embodiment, the alert analysis module 511, the load estimation module 512, the virtual server alignment determination module 513, the setting parameter determination module 514, and the setting parameter transmission module 515 are realized as programs, but this invention is not limited thereto. For example, special hardware may be used to realize the components.

Alternatively, a configuration may be employed in which at least two constituent modules from among the alert analysis module 511, the load estimation module 512, the virtual server alignment determination module 513, the setting parameter determination module 514, and the setting parameter transmission module 515 are implemented as one program.

Next, the traffic status is described.

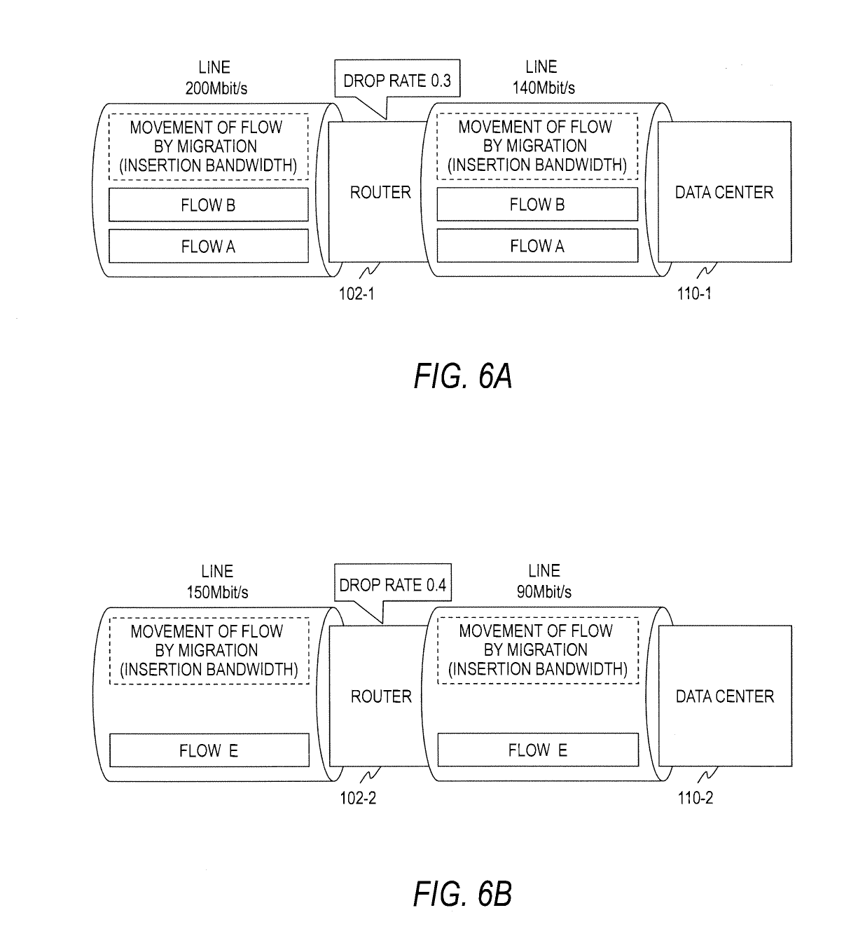

FIGS. 6A and 6B are explanatory diagrams illustrating examples of traffic statuses of the routers 102-1 and 102-2, respectively, according to the embodiment of this invention.

It should be noted that it is assumed below that the packet drop rate of the router 102-1 is “0.3” and the packet drop rate of the router 102-2 is “0.4”. It is assumed that the limit bandwidth of lines (communication routes) connecting the router 102-1 and data center 110-1 is “300 Mbit/s”, and the limit bandwidth of lines (communication routes) connecting the router 102-2 and data center 110-2 is “300 Mbit/s”. It is assumed that a communication bandwidth (insertion bandwidth) generated by the movement of the VM 106 is “50 Mbit/s”. It is also assumed that a used bandwidth of the line connecting the router 102-1 and the router 102-4 is “200 Mbit/s” and a used bandwidth of the line connecting the router 102-2 and the router 102-4 is “150 Mbit/s”.

In this case, a used bandwidth of the line (communication route) connecting the router 102-1 and the data center 110-1 is “140 Mbit/s”. Similarly, a used bandwidth of the line (communication route) connecting the router 102-2 and the data center 110-2 is “90 Mbit/s”.

In the case where the VM 106-4 is to be moved, when it is assumed that both the communication route via the router 102-1 and the communication route via the router 102-2 can be selected, it is difficult to determine which of the routers 102 the communication bandwidth (insertion bandwidth) generated by the movement of the VM 106-4 is to be moved to.

For example, in a case where the route is determined based only on the limit bandwidth, the line bandwidths available in the router 102-1 and the router 102-2 are “100 Mbit/s” and “150 Mbit/s”, respectively, and hence the communication route via the router 102-2 having more available line bandwidth is selected.

On the other hand, in a case where the communication route is determined based on the packet drop rate, the router 102-1 has lower packet drop rate than the router 102-2, and hence the communication route via the router 102-1 is selected.

As described above, the communication route to be selected is changed depending on the parameter used, and hence a unified evaluation criterion is needed. Accordingly, in this embodiment, based on the information obtained from the AFM packet, the communication route is selected through use of more detailed values indicating changes in traffic status in the line bandwidth. In other words, this embodiment has a feature in that the occurrence probability of packet drop is used.

The concept of the occurrence probability of packet drop is now described.

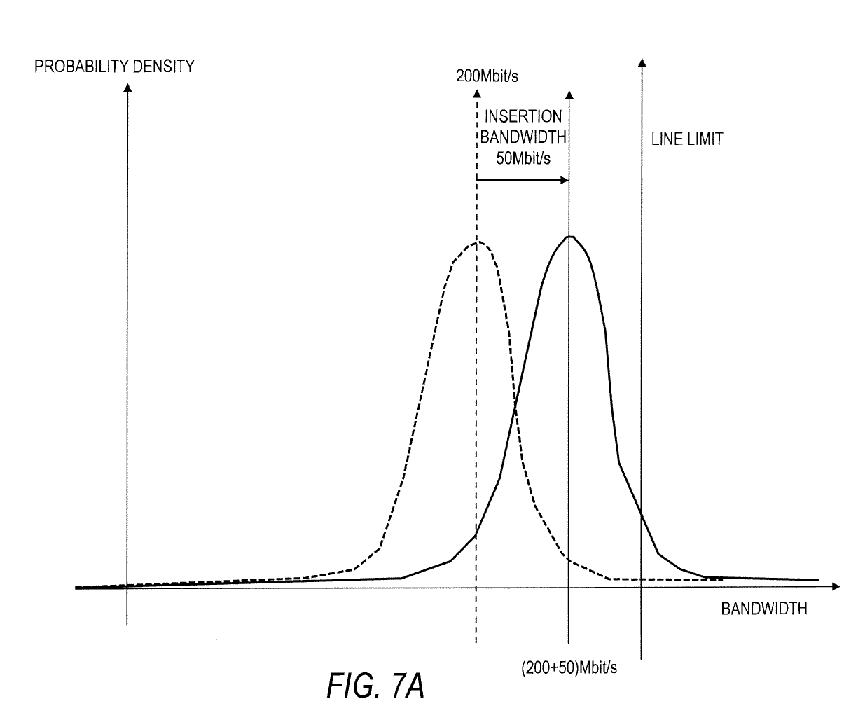

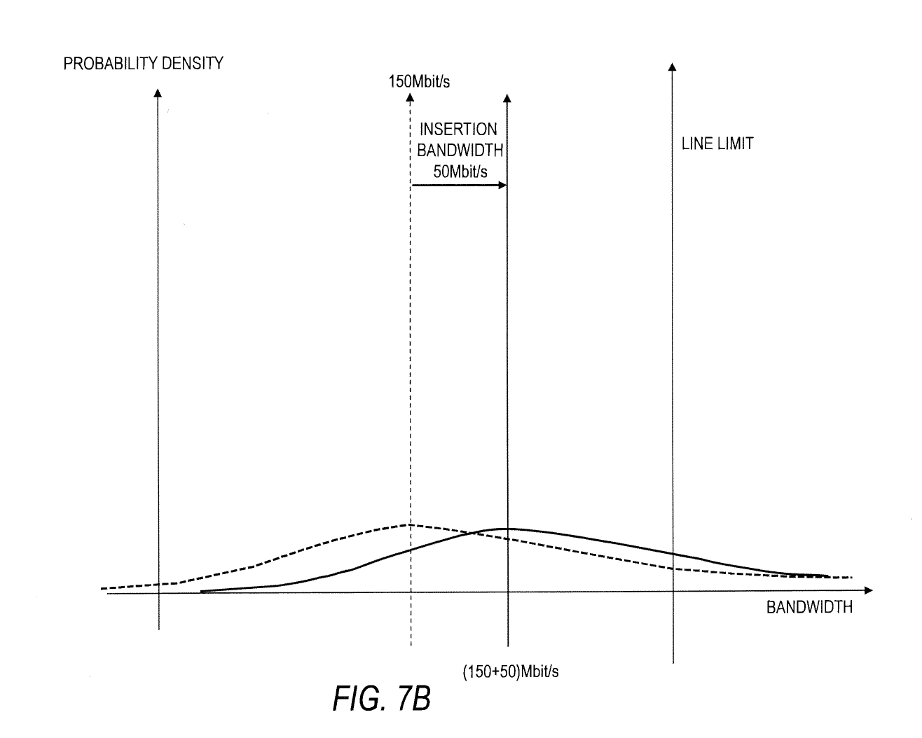

FIGS. 7A and 7B are explanatory graphs showing examples of distributions of traffic flowing through the routers 102 according to this embodiment. FIG. 7A shows the distribution of traffic flowing through the router 102-1, and FIG. 7B shows the distribution of traffic flowing through the router 102-2.

It should be noted that the horizontal axis represents the amount of bandwidth of communication flowing through the line, and the vertical axis represents a probability density distribution with respect to the amount of bandwidth of communication. The distributions as shown in FIGS. 7A and 7B are hereinafter referred to as traffic distributions.

In FIGS. 7A and 7B, the broken line graph represents the current distribution of traffic, and the solid line graph represents the distribution of traffic in a case where the insertion bandwidth is added.

As shown in FIGS. 7A and 7B, the used amount of bandwidth in the line (communication route) is not fixed and changes by the moment. Therefore, the characteristic of the change in used amount of bandwidth in the line (communication route) also needs to be considered. The routers 102 to which the AFM is applied can obtain a standard deviation in the traffic distribution from the AFM packet. Accordingly, in this embodiment, the standard deviation in the traffic distribution is used as information indicating the characteristic of the change in used amount of bandwidth in the line (communication route).

As shown in FIG. 7A, the traffic distribution of the router 102-1 is a reference distribution with the average value of the bandwidth being “200 M”. On the other hand, as shown in FIG. 7B, the traffic distribution of the router 102-2 is a distribution with high variance and with the average value of the bandwidth being “150 M”.

Before the movement of the flow, the traffic distributions are the graphs represented by the broken lines, and the router 102-2 has higher probability density of exceeding the line limit than the router 102-1. This indicates that, before the movement of the VM 106, the router 102-2 has higher probability that the limit bandwidth is exceeded (occurrence probability of packet drop) than the router 102-1.

However, in a case where the flow is moved, the traffic distributions are the graphs represented by the solid lines, and the router 102-1 has higher probability density of exceeding the line limit than the router 102-2.

This indicates that, in a case where the flow is moved to pass through the router 102-1, rapid packet drop may occur. On the other hand, in a case where the flow is moved to pass through the router 102-2, the amount of packet drop undergoes very little change.

As shown in FIGS. 7A and 7B, in a case where the standard deviation in the traffic distribution, that is, the value indicating the breadth of the traffic distribution is considered, a parameter (occurrence probability of packet drop) for estimating an increase in amount of packet drop may be defined.

The occurrence probability of packet drop is defined here as expressed by Equation (1) below. σ is the standard deviation in the traffic distribution.

$$Potency = exp ( - \frac{{( Line Limit - ( Total Bandwidth + Insertion Bandwidth ) )}^{2}}{2 * {σ}^{2}} ) \qquad ( 1 )$$

In this embodiment, Equation (1) is used to calculate the occurrence probability of packet drop after the movement of the VM 106.

The total bandwidth and the insertion bandwidth represent values of the amounts of communication that are actually flowing. On the other hand, σ is a value representing a range of the amount of communication in each flow. It should be understood that the occurrence probability of packet drop is a parameter that takes into consideration the change in amount of communication in the flow.

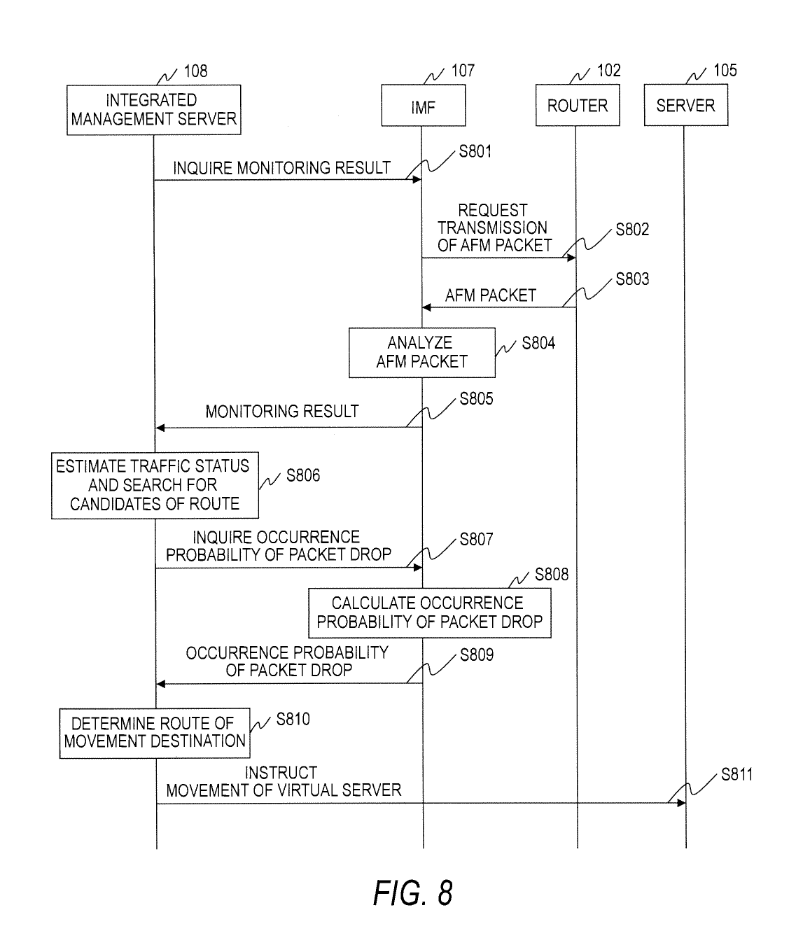

FIG. 8 is a sequence chart illustrating a flow of processing according to the first embodiment of this invention.

The integrated management server 108 inquires the monitoring result of each of the routers from the IMF 107 (Step S801). It should be noted that the integrated management server 108 starts processing in a case where a request to move the VM 106 is received from the client 101 or other such occasions. The movement request at least includes identification information of the client 101 subject to processing, and identification information of the VM 106 as the movement target.

It should be noted that the integrated management server 108 may perform the processing periodically.

The IMF 107 receives the inquiry from the integrated management server 108, and transmits a request to transmit an AFM packet in order to obtain the AFM packet from each of the routers 102 (Step S802). It should be noted that the routers 102 may transmit the AFM packet to the IMF 107 periodically.

Each of the routers 102 receives the request to transmit the AFM packet, generates the AFM packet and transmits the generated AFM packet to the IMF 107 (Step S803).

The IMF 107 analyzes the received AFM packet to monitor the traffic status for each of the routers 102 (Step S804). Further, the IMF 107 registers the communication information included in the AFM packet to a database. Thereafter, the IMF 107 responds with the monitoring result of each of the routers 102 (Step S805).

The integrated management server 108 estimates the future amount of communication bandwidth for each of the data centers 110 based on the obtained monitoring result, and searches for candidates of the communication route (data center 110) of the movement destination based on the estimation result (Step S806). The candidates of the communication route of the movement destination are hereinafter also referred to as candidate routes.

The integrated management server 108 inquires the occurrence probability of packet drop of the router 102 included in the found candidate route from the IMF 107 (Step S807). The router 102 included in the candidate route is hereinafter also referred to as a target router 102.

It should be noted that the inquiry about the occurrence probability of packet drop at least includes identification information of the router 102 included in the communication route before the movement, and identification information of the target router 102.

The IMF 107 calculates the occurrence probability of packet drop for each of the target routers 102 (Step S808), and responds with the calculated occurrence probability of packet drop (Step S809).

The integrated management server 108 determines the route of the movement destination based on the occurrence probability of packet drop (Step S810). Thereafter, the integrated management server 108 instructs the servers 105 of a movement source and the movement destination to move the VM 106 (Step S811).

Next, details of the processing of each of the IMF 107 and the integrated management server 108 are described.

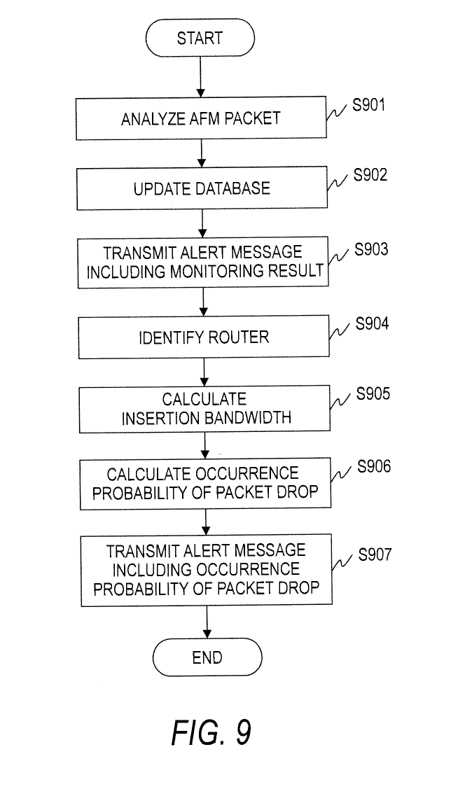

FIG. 9 is a flowchart illustrating the details of the processing executed by the IMF 107 according to the first embodiment of this invention.

In a case of receiving the inquiry about the monitoring result from the integrated management server 108, the IMF 107 obtains the AFM packet from each of the routers 102, and analyzes the AFM packet to monitor the traffic status of each of the routers 102 (Step S901). In this manner, the IMF 107 may obtain necessary information such as the amount of communication for each flow in each of the routers 102.

The IMF 107 registers the monitoring result and the received AFM packet to the database (Step S902). The IMF 107 also generates the alert message including the monitoring result, and transmits the alert message to the integrated management server 108 (Step S903). It should be noted that the monitoring result includes the traffic distribution for each flow in each of the routers 102, the standard deviation of each flow in each of the routers 102, and the like.

In a case of receiving the inquiry about the occurrence probability of packet drop from the integrated management server 108, the IMF 107 identifies the target router 102 based on the identification information of the target router 102 included in the inquiry (Step S904). The IMF 107 also calculates bandwidth in the target flow (insertion bandwidth) based on the identification information of the router 102 included in the route before the movement, which is included in the inquiry (Step S905).

The IMF 107 reads data corresponding to the target router 102 from the database, and substitutes the read data and the calculated insertion bandwidth into Equation (1) to calculate the occurrence probability of packet drop (Step S906).

The IMF 107 generates the alert message including the calculated occurrence probability of packet drop, and transmits the alert message to the integrated management server 108, with which the processing is ended (Step S907).

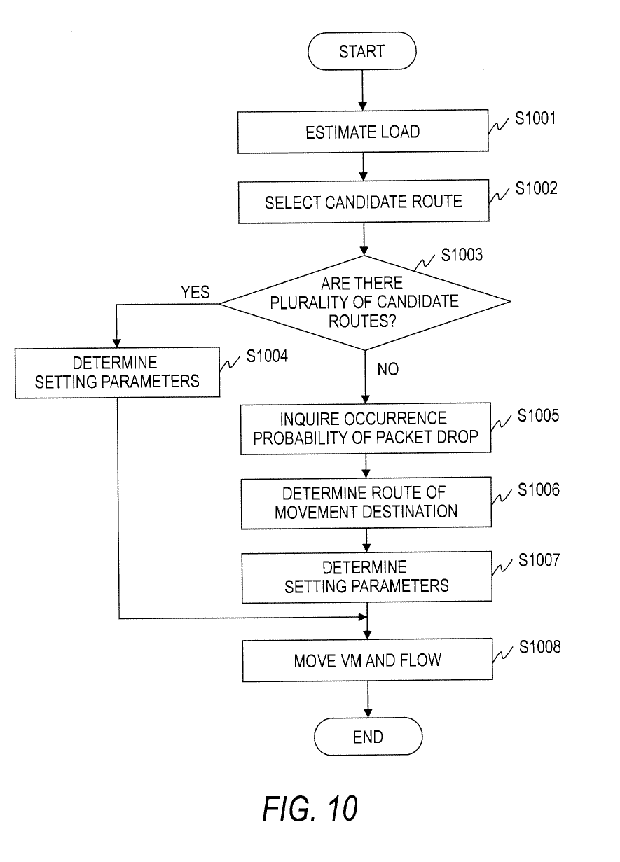

FIG. 10 is a flowchart illustrating the details of the processing executed by the integrated management server 108 according to the first embodiment of this invention.

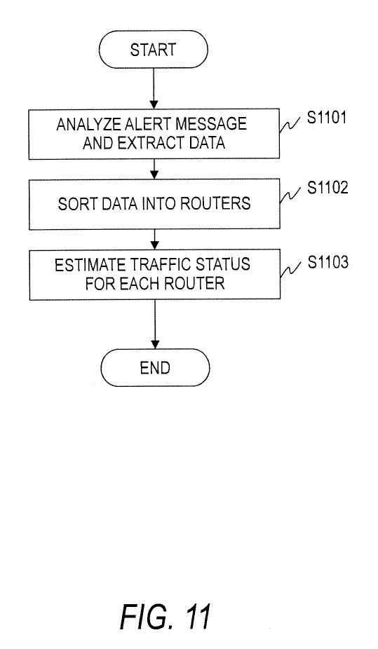

The integrated management server 108 analyzes the traffic of the flow in each of the communication routes connecting from the client 101 to the data centers 110 based on the monitoring result obtained from the IMF 107, to thereby estimate the load on each of the data centers 110, that is, the amount of communication bandwidth of each of the data centers 110 (Step S1001). It should be noted that the processing of estimating the load is described below with reference to FIG. 11.

In the processing of estimating the load, processing based on the statistical information of the flow that passes through each of the routers 102 is executed. Specifically, the communication route is selected based on the regularity (periodicity) of the change in the flow. However, the statistical information does not take into consideration the rapid change in the flow, and hence the selected route may not necessarily be an appropriate route. Accordingly, this embodiment has a feature in that the occurrence probability of packet drop is used as a parameter for taking into consideration the rapid change in the flow.

The integrated management server 108 selects the candidate route based on the estimation result of the load (Step S1002). It should be noted that in a case where the amounts of communication bandwidth of the data centers 110 are estimated to be substantially equal to one another, a plurality of candidate routes are selected.

The integrated management server 108 determines whether or not a plurality of candidate routes have been selected (Step S1003). In other words, it is determined whether or not there are at least two candidate routes.

In a case where it is determined that the number of candidate routes is not plural, in other words, that the number of candidate routes is one, the integrated management server 108 determines the candidate route as the communication route of the movement destination, and determines setting parameters for moving the flow to the determined communication route (Step S1004), with which the processing proceeds to Step S1008. The setting parameters include an IP address of the router 102 included in the communication route, an IP address of the VM 106, setting values of the VM 106, and the like.

In a case where it is determined that there are a plurality of candidate routes, the integrated management server 108 inquires the occurrence probability of packet drop of each of the routers 102 included in the candidate routes from the IMF 107 (Step S1005). It should be noted that the inquiry at least includes the identification information of the routers 102 included in the candidate routes.

In a case of obtaining the probabilities of occurrence of packet drop from the IMF 107, the integrated management server 108 determines an optimal route from among the candidate routes based on the probabilities of occurrence of packet drop (Step S1006). The following methods may be used to search for the optimal route from among the candidate routes.

In a case of searching only the routers 102 (for example, routers 102-1, 102-2, 102-3) for connecting the data centers 110 and an external network, the integrated management server 108 selects the communication route that passes through the router 102 having the lowest occurrence probability of packet drop.

Alternatively, in a case where all the routers 102 included in the communication routes are to be considered, the communication route having the smallest total value, average value, or the like of the probabilities of occurrence of packet drop of the routers 102 is selected.

Yet alternatively, the integrated management server 108 calculates a ratio of the used bandwidth to the limit bandwidth for each of the routers 102, and calculates a total value of values obtained by multiplying the ratio by the occurrence probability of packet drop for each of the communication routes. The integrated management server 108 selects the communication route having the smallest total value.

It should be noted that the above-mentioned methods of selecting the communication route are merely examples, and any method may be used as long as the method uses the occurrence probability of packet drop.

Next, the integrated management server 108 sets the setting parameters for moving the VM 106 to the determined communication route (Step S1007), and the processing proceeds to Step S1008.

The integrated management server 108 transmits the setting parameters to the routers 102 and the servers 105, to thereby move the VM 106 and the target flow corresponding to the VM 106, with which the processing ends (Step S1008). It should be noted that the migration of the VM 106 is a known technology, and hence description thereof is omitted.

FIG. 11 is a flowchart illustrating the processing of estimating the load according to the first embodiment of this invention.

The integrated management server 108 analyzes the alert message received from the IMF 107 and extracts necessary data (Step S1101). Then, the integrated management server 108 sorts the extracted data into the routers 102 included in the communication routes connecting to the data centers 110 as candidates of the movement destination (Step S1102).

The integrated management server 108 uses an autoregressive integrated moving average (ARIMA) model or the like for each item of the sorted data to estimate the future traffic status (Step S1103). The ARIMA model is a model for estimating future values in time-series data.

The processing in the first embodiment is now described with reference to FIGS. 6A and 6B. It should be noted that a standard deviation of the distribution of traffic flowing through the line of the router 102-1 is assumed to be “50 Mbit/s”, and a standard deviation a of the distribution of traffic flowing through the line of the router 102-2 is assumed to be “90 Mbit/s”.

It is assumed that the integrated management server 108 has selected in Step S1002 both the communication route connecting to the data center 110-1 via the router 102-1 and the communication route connecting to the data center 110-2 via the router 102-2 as the candidate routes.

In a case of receiving the inquiry about the occurrence probability of packet drop from the integrated management server 108, the IMF 107 identifies the router 102-1 and the router 102-2 as the target routers 102 in Step S904. It should be noted that the router 102-4 is common to the communication routes, and hence is not considered here. It should be noted, however, that the router 102-4 may be identified as the target router 102.

The IMF 107 calculates the occurrence probability of packet drop of each of the router 102-1 and the router 102-2 in Step S906.

Specifically, the router 102-1 has the total bandwidth of “200 Mbit/s”, the insertion bandwidth of “50 Mbit/s”, the limit bandwidth of “300 Mbit/s”, and the standard deviation σ of “50 Mbit/s”, and when the values are substituted into Equation (1), the occurrence probability of packet drop of the router 102-1 is calculated to be “0.60”. Similarly, the router 102-2 has the total bandwidth of “150 Mbit/s”, the insertion bandwidth of “50 Mbit/s”, the limit bandwidth of “300 Mbit/s”, and the standard deviation a of “90 Mbit/s”, and when the values are substituted into Equation (1), the occurrence probability of packet drop of the router 102-2 is calculated to be “0.53”.

Therefore, the integrated management server 108 determines, in Step S1006, the communication route via the router 102-2, that is, the communication route connecting to the data center 110-2 as the communication route of the movement destination.

Through use of the occurrence probability of packet drop as described above, the probability that the packet drop occurs may be estimated.

It should be noted that, in the first embodiment, the IMF 107 and the integrated management server 108 are realized by using separate computers, but this invention is not limited thereto. For example, one computer having the functions of the IMF 107 and the functions of the integrated management server 108 may be used.

It should be noted that, in the first embodiment, the case where the VM 106 is actually moved has been described, but this invention is not limited thereto. For example, such configuration that the IMF 107 periodically monitors the communication routes connecting to the VMs 106 and the integrated management server 108 presents the change in communication route based on the monitoring result may be employed.

Further, in a case where the value of the insertion bandwidth in Equation (1) is “0”, Equation (1) may be used as an index for measuring communication quality of each of the routers 102.

Further, in the first embodiment, the selection of the communication route at the time of moving the VM 106 has been described. However, this invention is not limited thereto, and may also be applied to selection of the communication route at a time of moving a flow or at a time of moving an application.

In the first embodiment, the occurrence probability of packet drop is introduced as a parameter for measuring behavior of the traffic that cannot be estimated based only on the used bandwidth and the packet drop rate. The occurrence probability of packet drop is calculated through use of the standard deviation representing the breadth of the traffic distribution as expressed by Equation (1). In this manner, it is possible to estimate how many packets are dropped in a case where the traffic distribution having the breadth is moved by the insertion bandwidth, that is, a future increase in packet drop rate.

The occurrence probability of packet drop is a parameter indicating line quality, and in a case where the communication route having the lowest probability is selected as the communication route of the movement destination, safer and more appropriate movement of the VM 106 may be realized.

### Second Embodiment

A second embodiment of this invention is described. It should be noted that differences from the first embodiment are mainly described.

A configuration of a computer system, and configurations of the IMF 107 and the integrated management server 108 according to the second embodiment are the same as those of the first embodiment, and hence description thereof is omitted.

The second embodiment is different in the method of calculating the occurrence probability of packet drop. Specifically, the occurrence probability of packet drop is calculated by Equation (2) below. σ1 represents the insertion bandwidth, that is, the standard deviation in the traffic distribution of the flow in the communication route connected to the VM 106 before the movement.

$$Potency = exp ( - \frac{{( Line Limit - ( Total Bandwidth + Insertion Bandwidth ) )}^{2}}{2 * {( σ + {σ}_{1} )}^{2}} ) \qquad ( 2 )$$

At this time, the IMF 107 determines the traffic distribution in the flow as the movement target and further calculates the standard deviation in the flow as the movement target in Step S905. The other processing steps are the same as those of the first embodiment, and hence description thereof is omitted.

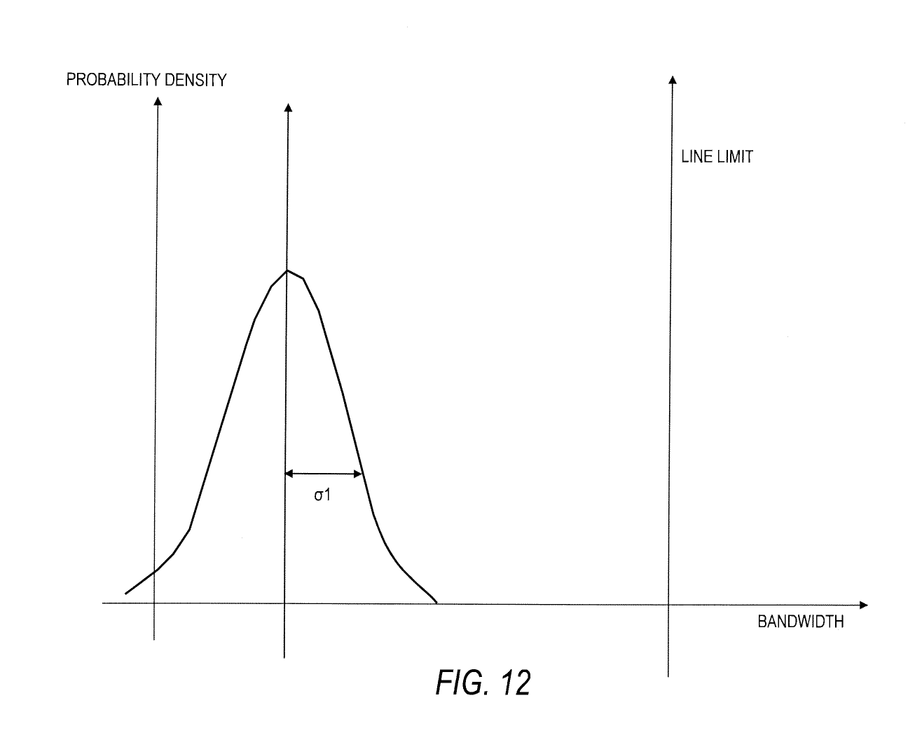

Equation (2) is a calculation equation taking the standard deviation of the traffic distribution of the insertion bandwidth also into consideration. In other words, in a case where a standard deviation of the traffic distribution of the insertion bandwidth is considered as shown in FIG. 12, a more accurate degree of risk that packet drop occurs may be estimated.

### Third Embodiment

A third embodiment of this invention is described. It should be noted that differences from the first embodiment are mainly described.

A configuration of a computer system, and configurations of the IMF 107 and the integrated management server 108 according to the third embodiment are the same as those of the first embodiment, and hence description thereof is omitted.

The third embodiment has a feature in that, in a case where an appropriate communication route cannot be determined in Step S1006 even in a case where Equation (1) or Equation (2) is used, the communication route is determined based further on the value using Equation (3) below.

$$Potency = \frac{( Total Bandwidth + Insertion Bandwidth )}{Line Limit} * \frac{1}{( 1 - Drop Ratio )} \qquad ( 3 )$$

In the equation, “Drop Ratio” represents a packet drop rate. The packet drop rate is a value that can be obtained from the router 102.

Examples of the case where the appropriate route cannot be determined even when Equation (1) or Equation (2) is used include a case where a difference between the values calculated by Equation (1) or Equation (2) is a predetermined threshold value or lower.

For example, regarding the router 102-1, in a case where the total bandwidth of “200 Mbit/s”, the insertion bandwidth of “50 Mbit/s”, the limit bandwidth of “300 Mbit/s”, and the packet drop rate of “0.3” are substituted into Equation (3), “1.19” is obtained as expressed by Equation (4) below.

$$Potency = \frac{250}{300} * \frac{1}{0.7} = 1.19 \qquad ( 4 )$$

For example, regarding the router 102-2, in a case where the total bandwidth of “150 Mbit/s”, the insertion bandwidth of “50 Mbit/s”, the limit bandwidth of “300 Mbit/s”, and the packet drop rate of “0.4” are substituted into Equation (3), “1.11” is obtained as expressed by Equation (5) below.

$$Potency = \frac{200}{300} * \frac{1}{0.6} = 1.11 \qquad ( 5 )$$

According to the third embodiment, Equation (3) is used, and hence a safer and more appropriate communication route can be selected. It should be noted that the value of Equation (3) does not have any unit, and is a parameter for evaluating the degree of risk that the packet drop occurs based only on the magnitude of the value. In other words, the value expressed by Equation (3) is a parameter for determining the degree of risk of occurrence of packet drop relatively.

### Fourth Embodiment

A fourth embodiment of this invention is described. It should be noted that differences from the first embodiment are mainly described.

A configuration of a computer system, and configurations of the IMF 107 and the integrated management server 108 according to the fourth embodiment are the same as those of the first embodiment, and hence description thereof is omitted.

The fourth embodiment has a feature in that, in a case where an appropriate communication route cannot be determined in Step S1006 even when Equation (1), Equation (2), or Equation (3) is used, the communication route is determined based further on the value using Equation (6) below.

$$Potency = \frac{{σ}_{1} * ( Total Bandwidth + Insertion Bandwidth )}{Line Limit} * \frac{1}{( 1 - Drop Ratio )} \qquad ( 6 )$$

Equation (6) is different in that the equation takes into consideration the standard deviation of the insertion bandwidth, which is not taken into consideration in Equation (3).

According to the fourth embodiment, Equation (6) is used, and hence a safer and more appropriate communication route can be selected.

### Fifth Embodiment

A fifth embodiment of this invention is described. It should be noted that differences from the first embodiment are mainly described.

A configuration of a computer system, and configurations of the IMF 107 and the integrated management server 108 according to the fifth embodiment are the same as those of the first embodiment, and hence description thereof is omitted.

The fifth embodiment has a feature in that, in a case where an appropriate communication route cannot be determined in Step S1006 even when Equation (1), Equation (2), Equation (3), or Equation (6) is used, the communication route is determined based further on the value using Equation (7) below.

$$Potency = \frac{( Total Bandwidth + Insertion Bandwidth )}{Line Limit} * Delay \qquad ( 7 )$$

For example, regarding the router 102-1, in a case where the average bandwidth of “200 Mbit/s” of the traffic flowing through the line, the insertion bandwidth of “50 Mbit/s”, the limit bandwidth of “300 Mbit/s”, and the delay of “100 ms” are substituted into Equation (7), “75” is obtained as expressed by Equation (8) below.

$$Potency = \frac{250}{300} * 90 = 75 \qquad ( 8 )$$

Regarding the router 102-2, in a case where the average bandwidth of “150 Mbit/s” of the traffic flowing through the line, the insertion bandwidth of “50 Mbit/s”, the limit bandwidth of “300 Mbit/s”, and the delay of “90 ms” are substituted into Equation (7), “66.6” is obtained as expressed by Equation (9) below.

$$Potency = \frac{200}{300} * 100 = 66.6 \qquad ( 9 )$$

It should be noted that the value expressed by Equation (7) does not have any unit, and is a parameter for evaluating the degree of risk that the packet drop occurs based only on the magnitude of the value. In other words, the value expressed by Equation (7) is a parameter for determining the degree of risk of occurrence of packet drop relatively.

According to the fifth embodiment, Equation (7) is used, and hence a safer and more appropriate communication route can be selected.

### Sixth Embodiment

A sixth embodiment of this invention is described. It should be noted that differences from the first embodiment are mainly described.

A configuration of a computer system, and configurations of the IMF 107 and the integrated management server 108 according to the sixth embodiment are the same as those of the first embodiment, and hence description thereof is omitted.

The sixth embodiment has a feature in that, in a case where an appropriate communication route cannot be determined in Step S1006 even when Equation (1), Equation (2), Equation (3), Equation (6), or Equation (7) is used, the communication route is determined based further on the value using Equation (10) below.

$$Potency = \frac{{σ}_{1} * ( Total Bandwidth + Insertion Bandwidth )}{Line Limit} * Delay \qquad ( 10 )$$

It should be noted that the value expressed by Equation (10) does not have any unit, and is a parameter for evaluating the degree of risk that the packet drop occurs based only on the magnitude of the value. In other words, the value expressed by Equation (10) is a parameter for determining the degree of risk of occurrence of packet drop relatively.

According to the sixth embodiment, Equation (10) is used, and hence a safer and more appropriate communication route can be selected.

It should be noted that there may be employed an embodiment in which the first embodiment is combined with at least two of the second to sixth embodiments.

While the present invention has been described in detail and pictorially in the accompanying drawings, the present invention is not limited to such detail but covers various obvious modifications and equivalent arrangements, which fall within the purview of the appended claims.

What is claimed is:

1. A computer system comprising a plurality of clients, a plurality of servers, a plurality of routers, an analysis device for monitoring communication statuses of the plurality of routers, and a management computer for controlling alignment of a virtual machine operating on each of the plurality of servers,
the virtual machine providing a predetermined service to the plurality of clients,
each of the plurality of clients including a first processor, a first memory connected to the first processor, and a first network interface for coupling to another device,
the each of the plurality of servers including a second processor, a second memory connected to the second processor, and a second network interface for coupling to another device,
each of the plurality of routers including a controller, and a third network interface for coupling to another device,
the analysis device including a fourth processor, a fourth memory connected to the fourth processor, and a fourth network interface for coupling to another device,
the management computer including a fifth processor, a fifth memory connected to the fifth processor, and a fifth network interface for coupling to another device,
the each of the plurality of servers including a virtualization control module for controlling the virtual machine,
the each of the plurality of routers including an information obtaining module for obtaining communication information for each flow, which is a set of a plurality of packets and is defined based on header information of packets that pass through the router, and for transmitting the obtained communication information to the analysis device,
the analysis device including:
an analysis module for analyzing the communication information received from the each of the plurality of routers and for outputting an analysis result; and
a probability calculation module for calculating, based on the analysis result, a first occurrence probability of packet drop representing a degree of risk that packet drop occurs in a router included in a communication route of a movement destination in a case where the virtual machine is moved,
the management computer including:
a load estimation module for estimating, based on the analysis result, a load for each of communication routes for moving the virtual machine as a movement target, and for identifying at least one candidate route, which is the communication route as a candidate of the movement destination; and
an alignment determination module for determining, based on the first occurrence probability of packet drop, the communication route of the movement destination from among the at least one candidate route.

2. The computer system according to claim 1,
wherein the analysis result includes a limit bandwidth, which is a maximum value of a communication bandwidth of the each of the plurality of routers, a total bandwidth, which is a bandwidth currently used by at least one flow that passes through the each of the plurality of routers, a first standard deviation in a distribution of amounts of communication of each flow that passes through the each of the plurality of routers, and an insertion bandwidth, which is a bandwidth of the flow that is moved along with the movement of the virtual machine,
wherein the management computer transmits a request to obtain the first occurrence probability of packet drop, which includes identification information of the router included in the at least one candidate route, and
wherein the analysis device is configured to:
identify the router included in the at least one candidate route based on the identification information of the router included in the at least one candidate route, which is included in the request to obtain the first occurrence probability of packet drop;
calculate the first occurrence probability of packet drop in the identified router based on the limit bandwidth, the total bandwidth, the insertion bandwidth, and the first standard deviation, which are included in the analysis result; and
transmit the calculated first occurrence probability of packet drop to the management computer.

3. The computer system according to claim 2,
wherein the analysis result further includes a second standard deviation in a distribution of amounts of communication of the flow that is moved along with the movement of the virtual machine,
wherein the probability calculation module calculates a second occurrence probability of packet drop in the identified router based on the limit bandwidth, the total bandwidth, the insertion bandwidth, the first standard deviation, and the second standard deviation, which are included in the analysis result, and
wherein the alignment determination module determines the communication route of the movement destination from among the at least one candidate route based on the first occurrence probability of packet drop and the second occurrence probability of packet drop.

4. The computer system according to claim 2,
wherein the analysis result further includes a packet drop rate of the each of the plurality of routers,
wherein the probability calculation module calculates a third occurrence probability of packet drop in the identified router based on the limit bandwidth, the total bandwidth, the insertion bandwidth, and the packet drop rate, which are included in the analysis result, and
wherein the alignment determination module determines the communication route of the movement destination from among the at least one candidate route based on the first occurrence probability of packet drop and the third occurrence probability of packet drop.

5. The computer system according to claim 2,
wherein the analysis result further includes a second standard deviation in a distribution of amounts of communication of the flow that is moved along with the movement of the virtual machine and a packet drop rate of the each of the plurality of routers,
wherein the probability calculation module calculates a fourth occurrence probability of packet drop in the identified router based on the limit bandwidth, the total bandwidth, the insertion bandwidth, the second standard deviation, and the packet drop rate, which are included in the analysis result, and
wherein the alignment determination module determines the communication route of the movement destination from among the at least one candidate route based on the first occurrence probability of packet drop and the fourth occurrence probability of packet drop.

6. The computer system according to claim 2,
wherein the analysis result further includes a delay time period of the each of the plurality of routers,
wherein the probability calculation module calculates a fifth occurrence probability of packet drop in the identified router based on the limit bandwidth, the total bandwidth, the insertion bandwidth, and the delay time period, which are included in the analysis result, and
wherein the alignment determination module determines, based on the first occurrence probability of packet drop and the fifth occurrence probability of packet drop, the communication route of the movement destination from among the at least one candidate route.

7. The computer system according to claim 2,
wherein the analysis result further includes a second standard deviation in a distribution of amounts of communication of the flow that is moved along with the movement of the virtual machine and a delay time period of the each of the plurality of routers,
wherein the probability calculation module calculates a sixth occurrence probability of packet drop in the identified router, based on the limit bandwidth, the total bandwidth, the insertion bandwidth, the first standard deviation, the second standard deviation, and the delay time period, which are included in the analysis result, and
wherein the alignment determination module determines the communication route of the movement destination from among the at least one candidate route based on the first occurrence probability of packet drop and the sixth occurrence probability of packet drop.

8. A virtual server alignment method in a computer system for providing a predetermined service to a client through use of a virtual server,
the computer system including a plurality of clients, a plurality of servers, a plurality of routers, an analysis device for monitoring communication statuses of the plurality of routers, and a management computer for controlling alignment of the virtual server operating on each of the plurality of servers,
each of the plurality of clients including a first processor, a first memory connected to the first processor, and a first network interface for coupling to another device,
the each of the plurality of servers including a second processor, a second memory connected to the second processor, and a second network interface for coupling to another device,
each of the plurality of routers including a controller, and a third network interface for coupling to another device,
the analysis device including a fourth processor, a fourth memory connected to the fourth processor, and a fourth network interface for coupling to another device,
the management computer including a fifth processor, a fifth memory connected to the fifth processor, and a fifth network interface for coupling to another device,
the each of the plurality of servers including a virtualization control module for controlling the virtual server,
the virtual server alignment method including:
a first step of obtaining, by the each of the plurality of routers, communication information for each flow, which is a set of a plurality of packets and is defined based on header information of packets that pass through the router, and transmitting the obtained communication information to the analysis device;
a second step of analyzing, by the analysis device, the communication information received from the each of the plurality of routers and transmitting an analysis result to the management computer;
a third step of estimating, by the management computer, a load for each of communication routes for moving the virtual server as a movement target based on the received analysis result, and identifying at least one candidate route, which is the communication route as a candidate of a movement destination;
a fourth step of calculating, by the analysis device, a first occurrence probability of packet drop representing a degree of risk that packet drop occurs in a router included in the communication route of the movement destination when the virtual server is moved based on the analysis result;
a fifth step of transmitting, by the analysis device, the calculated first occurrence probability of packet drop to the management computer; and
a sixth step of determining, by the management computer, the communication route of the movement destination from among the at least one candidate route based on the received first occurrence probability of packet drop.

9. The virtual server alignment method according to claim 8,
wherein the analysis result contains a limit bandwidth, which is a maximum value of a communication bandwidth of the each of the plurality of routers, a total bandwidth, which is a bandwidth currently used by at least one flow that passes through the each of the plurality of routers, a first standard deviation in a distribution of amounts of communication of each flow that passes through the each of the plurality of routers, and an insertion bandwidth, which is a bandwidth of the flow that is moved along with the movement of the virtual server,
wherein the third step includes the step of transmitting, after determining the at least one candidate route, a request to obtain the first occurrence probability of packet drop, which includes identification information of the router included in the at least one candidate route, and
wherein the fourth step comprises the steps of:
identifying the router included in the at least one candidate route based on the identification information of the router included in the at least one candidate route, which is included in the request to obtain the first occurrence probability of packet drop;
calculating the first occurrence probability of packet drop in the identified router based on the limit bandwidth, the total bandwidth, the insertion bandwidth, and the first standard deviation, which are included in the analysis result; and
transmitting the calculated first occurrence probability of packet drop to the management computer.

10. The virtual server alignment method according to claim 9,
wherein the analysis result further includes a second standard deviation in a distribution of amounts of communication of the flow that is moved along with the movement of the virtual server,
wherein the fourth step comprises the step of calculating a second occurrence probability of packet drop in the identified router based on the limit bandwidth, the total bandwidth, the insertion bandwidth, the first standard deviation, and the second standard deviation, which are included in the analysis result, and
wherein in the sixth step the communication route of the movement destination is determined from among the at least one candidate route based on the first occurrence probability of packet drop and the second occurrence probability of packet drop.

11. The virtual server alignment method according to claim 9,
wherein the analysis result further includes a packet drop rate of the each of the plurality of routers,
wherein the fourth step includes the step of calculating a third occurrence probability of packet drop in the identified router based on the limit bandwidth, the total bandwidth, the insertion bandwidth, and the packet drop rate, which are included in the analysis result, and
wherein in the sixth step the communication route of the movement destination is determined from among the at least one candidate route based on the first occurrence probability of packet drop and the third occurrence probability of packet drop.

12. The virtual server alignment method according to claim 9,
wherein the analysis result further includes a second standard deviation in a distribution of amounts of communication of the flow that is moved along with the movement of the virtual server and a packet drop rate of the each of the plurality of routers,
wherein the fourth step includes the step of calculating a fourth occurrence probability of packet drop in the identified router based on the limit bandwidth, the total bandwidth, the insertion bandwidth, the second standard deviation, and the packet drop rate, which are included in the analysis result, and
wherein in the sixth step the communication route of the movement destination is determined from among the at least one candidate route based on the first occurrence probability of packet drop and the fourth occurrence probability of packet drop.

13. The virtual server alignment method according to claim 9,
wherein the analysis result further includes a delay time period of the each of the plurality of routers,
wherein the fourth step includes the step of calculating a fifth occurrence probability of packet drop in the identified router based on the limit bandwidth, the total bandwidth, the insertion bandwidth, and the delay time period, which are included in the analysis result, and
wherein in the sixth step the communication route of the movement destination is determined from among the at least one candidate route based on the first occurrence probability of packet drop and the fifth occurrence probability of packet drop.

14. The virtual server alignment method according to claim 9,
wherein the analysis result further includes a second standard deviation in a distribution of amounts of communication of the flow that is moved along with the movement of the virtual server and a delay time period of the each of the plurality of routers,
wherein the fourth step includes the step of calculating a sixth occurrence probability of packet drop in the identified router based on the limit bandwidth, the total bandwidth, the insertion bandwidth, the second standard deviation, and the delay time period, which are included in the analysis result, and
wherein in the sixth step the communication route of the movement destination is determined from among the at least one candidate route based on the first occurrence probability of packet drop and the sixth occurrence probability of packet drop.

15. An alignment control apparatus in a computer system for providing, through use of a virtual machine operating on a server, a service to a user who uses a client coupled to the server via a network including a plurality of routers,
the alignment control apparatus comprising:
an analysis module for obtaining, from each of the plurality of routers, communication information for each flow, which is a set of a plurality of packets and is defined based on header information of packets that pass through the router, and for analyzing the communication information to output an analysis result including a limit bandwidth, which is a maximum value of a communication bandwidth of the each of the plurality of routers, a total bandwidth, which is a bandwidth currently used by at least one flow that passes through the each of the plurality of routers, a first standard deviation in a distribution of amounts of communication of each flow that passes through the each of the plurality of routers, and an insertion bandwidth, which is a bandwidth of the flow that is moved along with movement of the virtual machine;
a load estimation module for estimating a load for each of communication routes for moving the virtual machine as a movement target based on the analysis result, and identifying at least one candidate route, which is the communication route as a candidate of a movement destination;
a probability calculation module for calculating a first occurrence probability of packet drop representing a degree of risk that packet drop occurs in the router when the virtual machine is moved, based on the limit bandwidth, the total bandwidth, the insertion bandwidth, and the first standard deviation, which are included in the analysis result; and
an alignment determination module for determining the communication route of the movement destination from among the at least one candidate route, based on the first occurrence probability of packet drop.
